(19) United States
(12) Patent Application Publication
(10) Pub. No.: US 2026/0186349 A1
(43) Pub. Date: Jul. 2, 2026

(54) LIQUID CRYSTAL DISPLAY DEVICE

(71) Applicant: LG Display Co., Ltd., Seoul (KR)

(72) Inventor: Sejin JANG, Paju-si (KR)

(73) Assignee: LG Display Co., Ltd., Seoul (KR)

(21) Appl. No.: 19/403,707

(22) Filed: Nov. 28, 2025

(30) Foreign Application Priority Data
Dec. 31, 2024 (KR) 10-2024-0202328

(51) Int. Cl. G02F 1/1339; F21V 8/00; G02F 1/1335; G02F 1/1368

(52) U.S. Cl. CPC G02F 1/1339; G02B 6/0031; G02F 1/133512; G02F 1/133514; G02F 1/1368

(57) ABSTRACT

A liquid crystal display device can include a first substrate having a display area and a non-display area and bent downward in the non-display area, a second substrate disposed below the first substrate, a light source disposed below the first substrate in the non-display area, a reflective layer disposed on a bottom surface of the first substrate and a side surface of the second substrate in the non-display area, a light guide plate disposed below the second substrate, a plurality of concave patterns formed on a top surface of the first substrate in the non-display area, and a black sealing material disposed outside the first substrate and the second substrate and filling the plurality of concave patterns.

### CROSS-REFERENCE TO RELATED APPLICATIONS

This application claims priority to Korean Patent Application No. 10-2024-0202328 filed on December 31, 2024, in the Korean Intellectual Property Office, the entire disclosure of which is hereby expressly incorporated by reference.

### BACKGROUND

### Field

The present disclosure relates to a liquid crystal display device, and more particularly, to a liquid crystal display device capable of reducing a width of a bezel area and minimizing light leakage from a light source.

### Discussion of the Related Art

Recently, as the world enters an information era, a display field which visually expresses electrical information signals has been rapidly developed, and in response to this, various display devices having excellent performances such as thin-thickness, light weight, and low power have been developed. Specific examples of such a display device include a liquid crystal display (LCD), a plasma display panel device (PDP), a field emission display device (FED), and an organic light emitting display device (OLED).

Among the display devices, the liquid crystal display device is a device in which a liquid crystal panel is configured by disposing two substrates, each having electrodes for generating an electric field, so as to face each other and injecting a liquid crystal material between the two substrates. The optical anisotropy and birefringent properties of the liquid crystal molecules are controlled by an electric field generated by applying a voltage to the two electrodes of the liquid crystal panel, thereby displaying an image.

Attempts have been made to reduce the size of the bezel area through various methods to reduce the area of the entire display device and make the appearance beautiful. For example, a borderless type liquid crystal display device in which the width of the bezel area is minimized is being developed.

### SUMMARY OF THE DISCLOSURE

An object to be achieved by the present disclosure is to provide a liquid crystal display device in which a bezel area is minimized.

An object to be achieved by the present disclosure is to provide a liquid crystal display device capable of preventing damage to a bezel area due to an external impact in a lateral direction.

An object to be achieved by the present disclosure is to provide a liquid crystal display device in which light leakage from a light source is minimized and efficiency of a backlight unit is improved.

An object to be achieved by the present disclosure is to provide a display device, which addresses the above-identified and other limitations associated with the related art.

Objects of the present disclosure are not limited to the above-mentioned objects, and other objects, which are not mentioned above, can be clearly understood by those skilled in the art from the following descriptions.

In one embodiment of the present disclosure, a liquid crystal display device comprises a first substrate including a display area and a non-display area and bent downward in the non-display area; a second substrate disposed below the first substrate; a light source disposed below the first substrate in the non-display area; a reflective layer disposed on a bottom surface of the first substrate and a side surface of the second substrate in the non-display area; a light guide plate disposed below the second substrate; a plurality of concave patterns formed on a top surface of the first substrate in the non-display area; and a black sealing material disposed outside the first substrate and the second substrate and filling the plurality of concave patterns.

Other detailed matters of the embodiments of the present disclosure are included in the detailed description and the drawings.

According to the example configuration of the present disclosure, the bezel area can be minimized by bending the upper glass substrate.

According to the example embodiment of the present disclosure, the black resin is disposed in the bezel area to minimize damage to the bezel area and damage to the upper glass substrate due to external impact.

According to the example embodiment of the present disclosure, the light source is disposed in the bending area of the upper glass substrate to reduce the thickness of the display device and improve the efficiency of the backlight unit.

According to the example embodiment of the present disclosure, light leakage from the light source to the bezel area can be minimized by using a pattern formed on the upper glass substrate.

The effects according to the present disclosure are not limited to the contents exemplified above, and more various effects are included in the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic plan view of a liquid crystal display device according to an example embodiment of the present disclosure.

FIG. 2 is a schematic cross-sectional view for explaining a liquid crystal display panel of a liquid crystal display device according to an example embodiment of the present disclosure.

FIG. 3 is a schematic cross-sectional view of a liquid crystal display device according to an example embodiment of the present disclosure.

FIG. 4 is a schematic plan view for explaining a first substrate of a liquid crystal display device according to an example embodiment of the present disclosure.

FIG. 5 is a cross-sectional view taken along the line II-II' of FIG. 4.

FIG. 6 shows diagrams for explaining a concave pattern formed on a first substrate of a liquid crystal display device according to an example embodiment of the present disclosure.

FIGS. 7A to 7K are schematic diagrams for explaining a method of manufacturing a liquid crystal display device according to an example embodiment of the present disclosure.

FIG. 8 is a schematic cross-sectional view of a liquid crystal display device according to another example embodiment of the present disclosure.

FIG. 9 is a schematic cross-sectional view of a liquid crystal display device according to still another example embodiment of the present disclosure.

### DETAILED DESCRIPTION OF THE EMBODIMENTS

Advantages and characteristics of the present disclosure and a method of achieving the advantages and characteristics will be clear by referring to example embodiments described below in detail together with the accompanying drawings. However, the present disclosure is not limited to the example embodiments disclosed herein but will be implemented in various forms. The example embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the example embodiments of the present disclosure are merely examples, and the present disclosure is not limited thereto. Further, in the following description of the present disclosure, a detailed explanation of known related technologies can be omitted to avoid unnecessarily obscuring the subject matter of the present disclosure. The terms such as “including,” “having,” and “consist of” used herein are generally intended to allow other components to be added unless the terms are used with the term “only”. Any references to singular can include plural unless expressly stated otherwise.

Components are interpreted to include an ordinary error range even if not expressly stated.

When the position relation between two parts is described using the terms such as “on”, “above”, “below”, and “next”, one or more parts can be positioned between the two parts unless the terms are used with the term “immediately” or “directly”.

When an element or layer is disposed “on” another element or layer, another layer or another element can be interposed directly on the other element or therebetween.

Although the terms such as “first”, “second”, and the like are used for describing various components, these components are not confined by these terms. These terms are merely used for distinguishing one component from the other components and may not define order or sequence. Therefore, a first component to be mentioned below can be a second component in a technical concept of the present disclosure.

Like reference numerals generally denote like elements throughout the disclosure.

A size and a thickness of each component illustrated in the drawing are illustrated for convenience of description, and the present disclosure is not limited to the size and the thickness of the component illustrated. Further, the term “can” fully encompasses all the meanings and coverages of the term “may” and vice versa.

The features of various embodiments of the present disclosure can be partially or entirely adhered to or combined with each other and can be interlocked and operated in technically various ways, and the embodiments can be carried out independently of or in association with each other.

Hereinafter, example embodiments of the present disclosure will be described in detail with reference to accompanying drawings. All the components of each display device/apparatus according to all embodiments of the present disclosure are operatively coupled and configured.

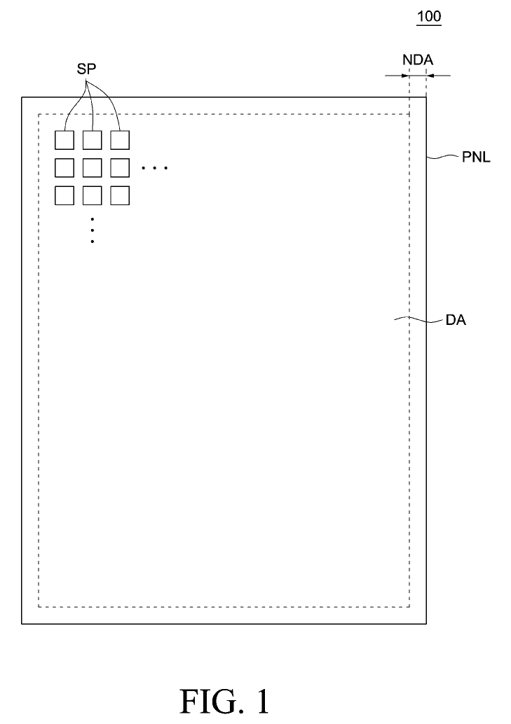

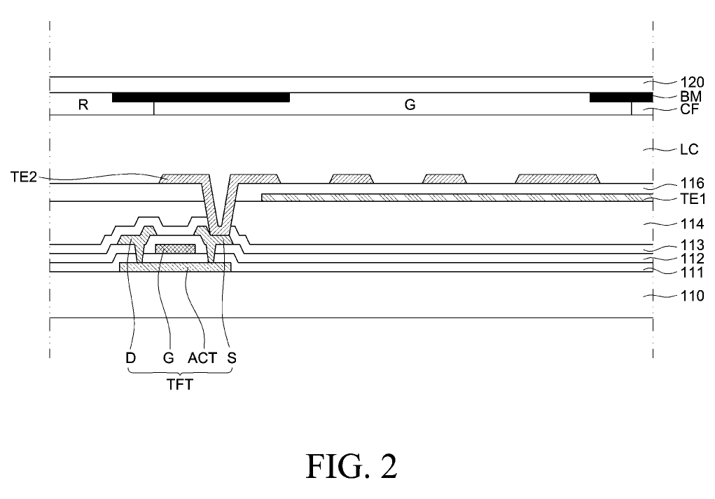

FIG. 1 is a schematic plan view of a liquid crystal display device according to an example embodiment of the present disclosure. FIG. 2 is a schematic cross-sectional view for explaining a liquid crystal display panel of a liquid crystal display device according to an example embodiment of the present disclosure. In FIG. 1, for the convenience of description, among various configurations of the liquid crystal display device 100, a liquid crystal display panel PNL and a plurality of sub pixels SP are illustrated.

Referring to FIGS. 1 and 2, the liquid crystal display device 100 according to the example embodiment of the present disclosure includes the liquid crystal display panel PNL. The liquid crystal display panel PNL is a panel that displays various images. The liquid crystal display panel PNL includes a display area DA and a non-display area NDA. The display area DA is an area in which the plurality of sub-pixels SP is disposed and an actual image is displayed, and the non-display area NDA is an outer area surrounding the display area DA, and no image is displayed. The non-display area NDA can be referred to as a bezel area. A wiring line and a driving circuit for driving a screen are disposed in the non-display area NDA.

The plurality of sub pixels SP can be defined in the liquid crystal display panel PNL. The plurality of sub-pixels SP is a minimum unit constituting the display area DA, and is an area for displaying one color each. For example, the plurality of sub-pixels SP can include a red sub-pixel, a green sub-pixel, and a blue sub-pixel. The plurality of sub-pixels SP can be defined in a matrix form as shown in FIG. 1.

The liquid crystal display panel PNL includes a first substrate 110, a second substrate 120, and a liquid crystal layer LC which is disposed between the first substrate 110 and the second substrate 120 to adjust the light transmittance.

The liquid crystal display device 100 according to the example embodiment of the present disclosure is a borderless display device. The first substrate 110, which is an upper substrate, is composed of a thin film transistor array substrate, and the second substrate 120, which is a lower substrate, is composed of a color filter substrate. For example, the display device 100 according to the example embodiment of the present disclosure is characterized in that the thin film transistor array substrate having a relatively large area is located on the color filter substrate by turning the liquid crystal display panel upside down unlike the prior art.

Accordingly, since the pad part components formed on the thin film transistor array substrate above are disposed to face the rear surface of the liquid crystal display panel PNL, a device such as an exterior cover (or a top case) for covering the pad part components is not required, thereby implementing a four-surface borderless type. In this case, as described above, a structure in which the thin film transistor array substrate is located on the top position and used as a viewing surface can be referred to as a flip-over-type.

The liquid crystal display panel PNL can be driven by a fringe field switching (FFS) method in which a fringe field formed between the first electrode TE1, which is a common electrode, and the second electrode TE2, which is a pixel electrode, penetrates the slit and drives liquid crystal molecules of the liquid crystal layer LC positioned on the pixel area to display images. As another example, the liquid crystal display panel PNL can be driven in an in-plane switching (IPS) method in which the first electrode TE1, which is a common electrode, and the second electrode TE2, which is a pixel electrode, are disposed in parallel, and liquid crystal molecules of the liquid crystal layer LC are driven by horizontal electric fields of the first electrode TE1 and the second electrode TE2, thereby displaying images.

The first substrate 110 is configured to support various components included in the liquid crystal display device 100 and protect the components from external impacts or external environments, and can be formed of a glass substrate.

The first substrate 110 supports various components of the liquid crystal display device 100. The first substrate 110 can include a display area DA and a non-display area NDA, as in the liquid crystal display panel PNL described above. The thin film transistor TFT, various lines and electrodes are formed on the first substrate 110 to define a plurality of sub-pixels. A color filter CF for displaying three primary colors of red, green, and blue and a black matrix BM partitioning each sub-pixel can be formed on the second substrate 120.

A plurality of gate lines and data lines are disposed on the first substrate 110 while crossing each other. The thin film transistor TFT can be disposed in an intersection area between the gate line and the data line, and can be connected to the second electrode TE2 formed in the display area DA.

A buffer layer can be disposed between the first substrate 110 and the thin film transistor TFT. The buffer layer blocks impurities introduced from the first substrate 110 during a process of forming the thin film transistor. In addition, the buffer layer protects various components of the display device 100 by preventing penetration of moisture (H₂O) and hydrogen (H₂) from the outside. The buffer layer can be made of an insulating material, and for example, an inorganic layer made of silicon nitride (SiNₓ), silicon oxide (SiOₓ), silicon oxynitride (SiON) or the like can be configured as a single layer or multilayer.

The thin film transistor TFT can be used as a driving element of the liquid crystal display device 100. The thin film transistor TFT includes an active layer ACT, a gate electrode G, a source electrode S, and a drain electrode D. In the liquid crystal display device 100 according to the example embodiment of the present disclosure, the thin film transistor TFT can be a thin film transistor TFT having a top gate structure in which the gate electrode G is disposed on the active layer ACT and the source electrode S and the drain electrode D are disposed on the gate electrode G. However, the present disclosure is not limited thereto. The thin film transistor TFT can have a bottom gate structure in which the active layer ACT is disposed on the gate electrode G and the gate electrode is disposed at the bottom.

Specifically, the active layer ACT is disposed on the first substrate 110. The active layer ACT can be formed of polysilicon (p-Si), amorphous silicon (a-Si), or an oxide semiconductor, but is not limited thereto.

The gate insulating layer 111 is disposed on the first substrate 110 and the active layer ACT. The gate insulating layer 111 can be made of silicon oxide (SiOx), silicon nitride (SiNx), or multiple layers thereof. The gate electrode G is disposed on the gate insulating layer 111. The gate electrode G is disposed on the gate insulating layer 111 so as to overlap the active layer ACT.

The gate electrode G can be formed of various conductive materials, such as magnesium (Mg), aluminum (Al), nickel (Ni), chromium (Cr), molybdenum (Mo), tungsten (W), gold (Au), or an alloy thereof, but is not limited thereto.

The interlayer insulating layer 112 is disposed on the gate insulating layer 111 and the gate electrode G. The interlayer insulating layer 112 can be made of silicon oxide (SiOₓ), silicon nitride (SiNₓ), or multiple layers thereof.

The source electrode S and the drain electrode D are disposed on the interlayer insulating layer 112. The source electrode S and the drain electrode D are electrically connected to the active layer ACT through contact holes formed in the gate insulating layer 111 and the interlayer insulating layer 112. The source electrode S and the drain electrode D can be formed of various conductive materials, such as magnesium (Mg), aluminum (Al), nickel (Ni), chromium (Cr), molybdenum (Mo), tungsten (W), gold (Au), or an alloy thereof, but are not limited thereto.

The passivation layer 113 is disposed on the source electrode S and the drain electrode D. The passivation layer 113 is an insulating layer for protecting components disposed below the passivation layer 113. The passivation layer 113 can be configured by a single layer or a double layer of silicon oxide (SiOₓ) or silicon nitride (SiNₓ), but is not limited thereto.

The planarization layer 114 is disposed on the passivation layer 113. The planarization layer 114 is an insulating layer that planarizes an upper portion of the first substrate 110 on which the thin film transistor TFT is disposed. The planarization layer 114 can be formed of an organic material, and for example, can be configured by a single layer or a double layer of polyimide or photo acryl, but is not limited thereto. The planarization layer 114 can include a contact hole for electrically connecting the thin film transistor TFT and the second electrode TE2.

A first electrode TE1 which is a common electrode is formed on the planarization layer 114. The first electrode TE1 is electrically connected to the common wiring. The first electrode TE1 is configured by one large electrode and is commonly used for the sub-pixels SP.

Meanwhile, the liquid crystal display device 100 according to the example embodiment of the present disclosure can include a touch element. In this case, the first electrode TE1 can include a plurality of common electrode blocks. The common electrode blocks configured by the first electrode TE1 can function as touch electrodes of a capacitive type touch element.

The first electrode TE1 can be made of a transparent conductive material. For example, the transparent conductive material can be formed of tin oxide (TO), indium tin oxide (ITO), indium zinc oxide (IZO), indium zinc tin oxide (ITZO), or the like, but is not limited thereto.

The protective layer 116 is disposed on the first electrode TE1. The protective layer 116 is a layer for insulating the first electrode TE1 and the second electrode TE2 and can be formed of an inorganic insulating material or an organic insulating material. For example, the protective layer 116 can be configured as a single layer or multilayer made of silicon oxide (SiOₓ) or silicon nitride (SiNₓ). However, the present disclosure is not limited thereto.

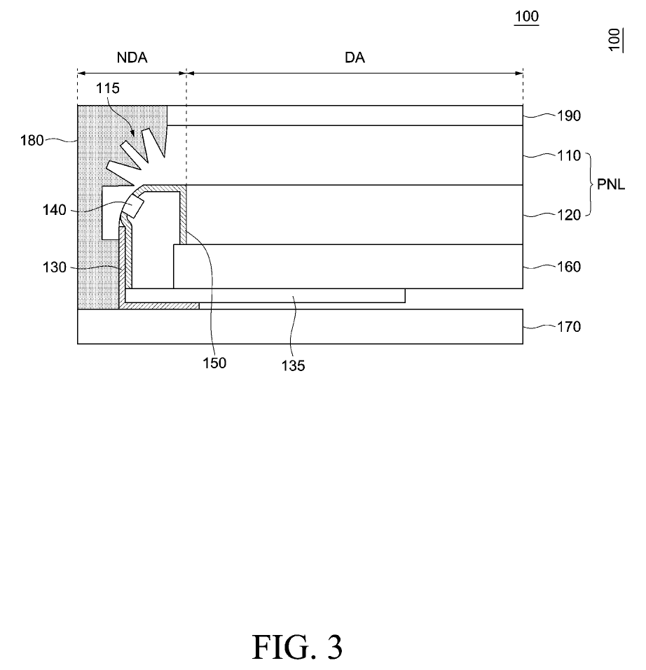

The second electrode TE2 is disposed on the protective layer 116. The second electrode TE2 can be a pixel electrode. The second electrode TE2 is electrically connected to the drain electrode D through a contact hole penetrating through the protective layer 116, the planarization layer 114, and the passivation layer 113 therebelow. FIG. 3 illustrates that the second electrode TE2 is in contact with the drain electrode D of the thin film transistor TFT. However, in some embodiments, the second electrode TE2 can be in contact with the source electrode S of the thin film transistor TFT.

The second electrode TE2 can be formed in a structure having a plurality of slits. In this case, the second electrode TE2 can be formed in a straight line shape or a zigzag shape having at least one curved shape. In the liquid crystal display device 100 illustrated in FIG. 3, a structure in which the second electrode TE2 has a plurality of slits and the first electrode TE1 has a single electrode block is illustrated. However, the present disclosure is not limited thereto. The second electrode TE2 can have a single electrode block and the first electrode TE1 can have a plurality of slits.

For example, the second electrode TE2 can be made of a transparent conductive material. For example, the transparent conductive material can be formed of tin oxide (TO), indium tin oxide (ITO), indium zinc oxide (IZO), indium zinc tin oxide (ITZO), or the like, but is not limited thereto.

When a voltage is applied to the second electrode TE2 through the thin film transistor TFT, the liquid crystal molecules of the liquid crystal layer LC are rotated by dielectric anisotropy by an electric field formed between the second electrode TE2 and the first electrode TE1, and the light transmittance of light passing through the display area DA is changed according to the degree of rotation of the liquid crystals. Accordingly, the amount of light of the sub-pixel SP can be controlled.

Meanwhile, referring to FIG. 2, the liquid crystal display panel PNL can include an upper polarizer disposed on an upper surface of the first substrate 110 and a lower polarizer disposed on a lower surface of the second substrate 120. In this case, the lower polarizer and the upper polarizer have an area larger than that of the display area DA and can have an area smaller than that of the display panel PNL. The lower polarizer and the upper polarizer can be formed by stretching poly-vinyl alcohol (PVA) dyed with iodine. The lower polarizer and the upper polarizer have their absorption axes formed in the stretching direction so that the light vibrating in a direction parallel to the absorption axis is absorbed and only the light vibrating in a direction perpendicular to the absorption axis is selectively transmitted.

Hereinafter, components of the liquid crystal display device 100 according to an example embodiment of the present disclosure will be described with reference to FIGS. 3 to 5.

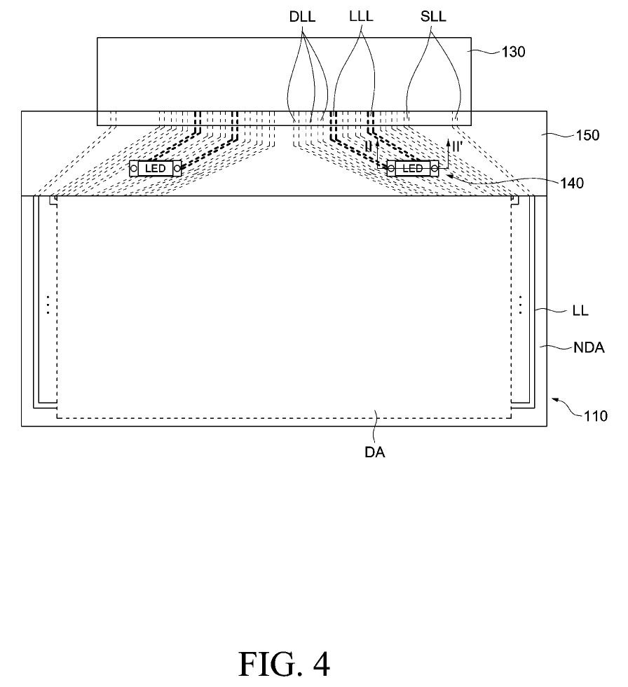

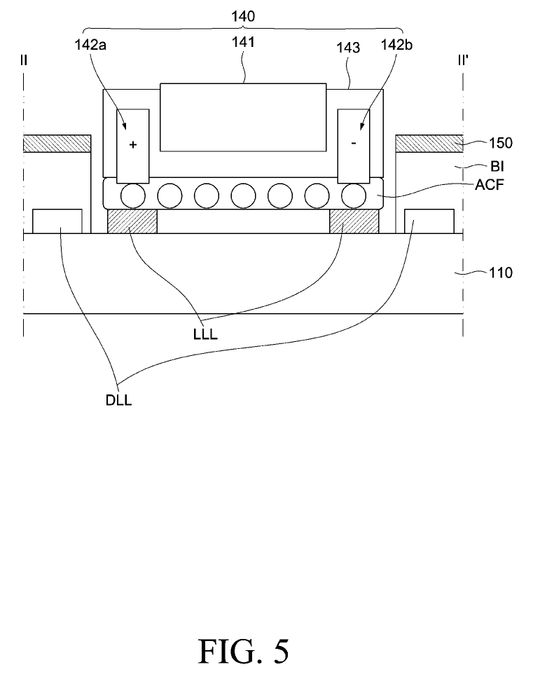

FIG. 3 is a schematic cross-sectional view of a liquid crystal display device according to an example embodiment of the present disclosure. FIG. 4 is a schematic plan view for explaining a first substrate of a liquid crystal display device according to an example embodiment of the present disclosure. FIG. 5 is a cross-sectional view taken along the line II-II' of FIG. 4.

Referring to FIG. 3, a liquid crystal display device 100 according to the present disclosure includes a liquid crystal display panel PNL including a first substrate 110 and a second substrate 120, a flexible film 130, a printed circuit board 135, a light source 140, a reflective layer 150, a light guide plate 160, a bottom cover 170, a black sealing material 180, and a protective coating layer 190. Referring to FIG. 3, at least one side of the first substrate 110 is bent downward in the non-display area NDA. The first substrate 110 can be bent in the non-display area NDA to extend in a direction perpendicular to the display area DA.

In this case, the first substrate 110 can include a concave pattern 115 in the bending area to facilitate bending. The concave pattern 115 has a shape recessed downward from the top surface by removing a portion of the first substrate 110. The concave pattern 115 reduces stress applied to the first substrate 110 during bending, and allows the first substrate 110 to be easily bent in the bending area. The number and shape of the concave pattern 115 can be variously adjusted.

The flexible film 130, the light source 140, and the reflective layer 150 are disposed on one side of the first substrate 110.

Referring to FIG. 3, the flexible film 130 is disposed on one side of the first substrate 110. One side of the flexible film 130 can be attached to the lower surface of the first substrate 110 in the non-display area NDA, and the other side thereof can be attached to the printed circuit board 135. The flexible film 130 can be bent in the non-display area NDA so that the other side of the flexible film 130 overlaps the lower portion of the second substrate 120. The flexible film 130 transmits various signals from the printed circuit board 135 to the liquid crystal display panel PNL.

Specifically, referring to FIG. 4, the flexible film 130 can transmit a gate driving signal, a data driving signal, and a light source driving signal to the liquid crystal display panel PNL through a plurality of link lines LL formed on the first substrate 110.

For example, the plurality of link lines LL disposed on the rear surface of the first substrate 110 can be a plurality of gate link lines SLL, a plurality of data link lines DLL, and a plurality of light source link lines LLL. The plurality of gate link lines SLL is wiring lines for connecting a plurality of gate lines and a gate driving circuit formed in the display area DA of the first substrate 110, and the plurality of data link lines DLL is wiring lines for connecting a plurality of data lines and a data driving circuit formed in the display area DA of the first substrate 110.

Further, the plurality of light source link lines LLL is wiring lines for transmitting a signal for driving the light source 140 disposed in the non-display area NDA. The plurality of gate link lines SLL, the plurality of data link lines DLL, and the plurality of light source link lines LLL can extend from an end of a bottom surface of the first substrate 110 toward the display area DA of the first substrate 110.

Referring to FIG. 3, the printed circuit board 135 is attached to the flexible film 130. The printed circuit board 135 can be disposed below the light guide plate 160. The printed circuit board 135 can transmit various signals to a plurality of wiring lines formed on the first substrate 110. The printed circuit board 135 can transmit various signals to a plurality of wiring lines formed on the first substrate 110. For example, a timing controller, etc. can be disposed on the printed circuit board 135. The timing controller can supply various signals to the liquid crystal display panel PNL. For example, the timing controller generates a data driver control signal DDC and a gate driver control signal GDC to supply the generated data driver control signal DDC and gate driver control signal GDC to the liquid crystal display panel PNL.

In the liquid crystal display device 100 according to the embodiment of the present disclosure, the flexible film 130 and the printed circuit board 135 are disposed independently of each other, but the separate flexible film 130 and the printed circuit board 135 are not attached to each other, and the flexible printed circuit board FPCB can be integrally formed with the flexible film 130 and the printed circuit board 135, such that the flexible film 130 itself can serve as the printed circuit board 135.

The light source 140 is disposed at one side of the first substrate 110. In this case, the light source 140 can be implemented as a light emitting diode (LED) having advantages such as high efficiency, high luminance, and low power consumption, but is not limited thereto.

Referring to FIGS. 3 and 4, a plurality of light sources 140 can be disposed on the bottom surface of the first substrate 110 in the non-display area NDA, and their positions and placement densities can be appropriately selected in consideration of optical properties. The light source 140 can receive an electrical signal through the printed circuit board 135 and can be turned on or off. A circuit for electrically connecting the light source 140 and the light source driver is formed on the printed circuit board 135. The light source 140 can receive a signal through a plurality of light source link lines LLL through the flexible film 130.

Referring to FIG. 5, the light source 140 can include a light emitting unit 141, a first electrode 142a, a second electrode 142b, and a case 143. The light emitting unit is turned on and off by receiving a driving signal applied from a plurality of light source link lines LLL connected to the first electrode 142a and the second electrode 142b. In this case, the first electrode 142a and the second electrode 142b can be connected to a plurality of light source link lines LLL connected through an anisotropic conductive film (ACF). In this case, the gate link line SLL and the plurality of data link lines DLL may not be disposed below the light source 140 to bypass the light source 140.

Referring to FIG. 3, the reflective layer 150 is disposed on the bottom surface of the first substrate 110. The reflective layer 150 can expose the light source 140 through a hole penetrating the reflective layer 150, but is not limited thereto. The efficiency of light incident on the light guide plate 160 can be improved through the reflective layer 150.

The reflective layer 150 extends from the bottom surface of the first substrate 110 toward the light guide plate 160 in the non-display area NDA to be disposed on the side surface of the second substrate 120. Since the light source 140 is attached to the bottom surface of the first substrate 110, when light emitted from the light source 140 is incident on the second substrate 120 or the first substrate 110 and the second substrate 120, light efficiency can be lowered and light leakage can occur. Therefore, in the non-display area NDA, the reflective layer 150 is disposed on the bottom surface of the first substrate 110 and the side surface of the second substrate 120 to improve the luminous efficiency.

Referring to FIG. 5, a black insulating layer BI is disposed between the first substrate 110 and the reflective layer 150. The black insulating layer BI can insulate the reflective layer 150 from the plurality of link lines LL disposed on the first substrate 110, for example, the data link line DLL, and prevent light emitted from the light source 140 from leaking. Like the reflective layer 150, the black insulating layer BI includes a through hole for exposing the light source 140. Therefore, an alignment process can be easily performed in the process of mounting the light source 140 by using the black insulating layer BI.

Referring to FIG. 3, the light guide plate 160 is disposed below the second substrate 120. The light guide plate 160 converts the traveling direction of light incident from the light source 140 to supply uniform surface light to the liquid crystal display panel PNL. For example, light incident from the light source 140 disposed on the side surface of the light guide plate 160 is evenly spread while traveling in the light guide plate 160 through total reflection, so that the light guide plate 160 can supply uniform surface light. The light guide plate 160 can be formed of a glass material or a light-transmitting resin such as polymethyl methacrylate or polycarbonate.

The bottom cover 170 is a case member that accommodates and protects components of the liquid crystal display device 100. The bottom cover 170 can be disposed on the bottom surfaces of the liquid crystal display panel PNL and the light guide plate 160. In FIG. 2, in order to provide a borderless type liquid crystal display device implementing a narrow bezel, it is illustrated that the bottom cover 170 includes only a horizontal support portion disposed under the light guide plate 160, but is not limited thereto. For example, the bottom cover 170 can be formed in a rectangular frame shape with vertically bent edges. Specifically, the cover bottom 170 can include a horizontal support portion disposed to face the rear surface of the light guide plate 160 and a vertical support portion extending from the horizontal support portion and disposed to surround the side surface of the liquid crystal display panel PNL.

The bottom cover 170 can include a material having high thermal conductivity and high rigidity so as to smoothly discharge heat from the driving circuit and the light source 140 to the outside. For example, the bottom cover 170 can be made of a metal plate such as aluminum, aluminum nitride (AlN), electro-galvanized steel sheet (EGI), stainless steel (SUS), gallium (SGLC), aluminum plated steel sheet (aka ALCOSTA), tin plated steel sheet (SPTE), or the like, but is not limited thereto.

In the non-display area NDA, a black sealing material 180 is disposed outside the liquid crystal display panel. For example, the black sealing material 180 can be disposed in a frame shape on an edge of the four surfaces of the liquid crystal display device 100. The black sealing material 180 is disposed outside the liquid crystal display panel PNL, the flexible film 130, and the light guide plate 160 to protect the liquid crystal display device 100 from external impacts in the lateral direction. Referring to FIG. 2, the black sealing material 180 can be disposed to be in direct contact with the bent first substrate 110 and can be disposed to fill the inside of the plurality of concave patterns 115 of the first substrate 110. By filling the inside of the concave pattern 115 of the first substrate 110, the black sealing material 180 can maintain the bending shape of the first substrate 110 and protect the first substrate 110 from an external impact. In addition, the black sealing material 180 can prevent light emitted from the light source 140 disposed on the lower surface of the first substrate 110 from leaking outward in the non-display area NDA.

The black sealing material 180 can be formed of a UV curable material to which a UV curable oligomer is added, such as epoxy acrylate, urethane acrylate, polyester acrylate, urethane, and silicone acrylate, but is not limited thereto. Further, a black sealing material 180 can include a black pigment or dye to prevent light leakage.

The protective coating layer 190 is disposed on the first substrate 110 so as to correspond to the display area DA. The protective coating layer 190 protects the liquid crystal display panel PNL from external impacts and scratches. Accordingly, the protective coating layer 190 can be formed of a material that is transparent and has excellent impact resistance and scratch resistance. Further, the protective coating layer 190 protects the liquid crystal display panel PNL from moisture permeating from the outside. Accordingly, the protective coating layer 190 can prevent the liquid crystal display panel PNL from deteriorating and thus deteriorating display quality.

The protective coating layer 190 can be a film made of a polymer such as polyimide, polyamide imide, polyethylene terephthalate, polymethyl methacrylate, polypropylene glycol, polycarbonate and the like. Alternatively, the protective coating layer 190 can be a hard coating layer formed from a composition formed of a cycloolefin (co)polymer, photoisotropic polycarbonate, photoisotropic polymethyl methacrylate, or the like. In addition, the protective coating layer 190 can have a multilayer structure in which various functional layers are stacked. For example, the protective coating layer 190 can include various functional layers such as an external light reflection reducing layer, a UV blocking layer, and the like.

Recently, a flip over type display device that uses a substrate on which a thin film transistor is disposed in a display device as a viewing surface has been actively developed. In particular, in the flip over type display device, since the substrate on which the thin film transistor is disposed is composed of an upper substrate, the pad portion is disposed toward the rear surface of the panel, so that a device such as an exterior cover for covering the pad portion can be deleted, thereby implementing a four-sided borderless type.

The liquid crystal display device according to an example embodiment of the present disclosure has a structure in which a thin film transistor array substrate is located on an upper portion and is used as a viewing surface. The array substrate located in the non-display area is bent to reduce the width of the non-display area and implement a narrow bezel. In particular, since the light source constituting the backlight unit is located on the rear surface of the first substrate and the flexible film, a space for disposing the light source is reduced, and a wiring is formed on an existing flexible film without forming a separate wiring for driving the light source, thereby reducing a wasted space. In addition, in the liquid crystal display device according to the example embodiment of the present disclosure, a black sealing material is disposed outside the bent first substrate to reduce an impact from the side surface. Further, the arrangement of the light source and the reflective layer disposed in the bending area can be adjusted, and the bending pattern of the first substrate can be utilized to prevent light leakage from the inside of the display device to the outside.

Hereinafter, various examples of the shape of the concave pattern 115 formed on the first substrate 110 will be described with reference to FIG. 4.

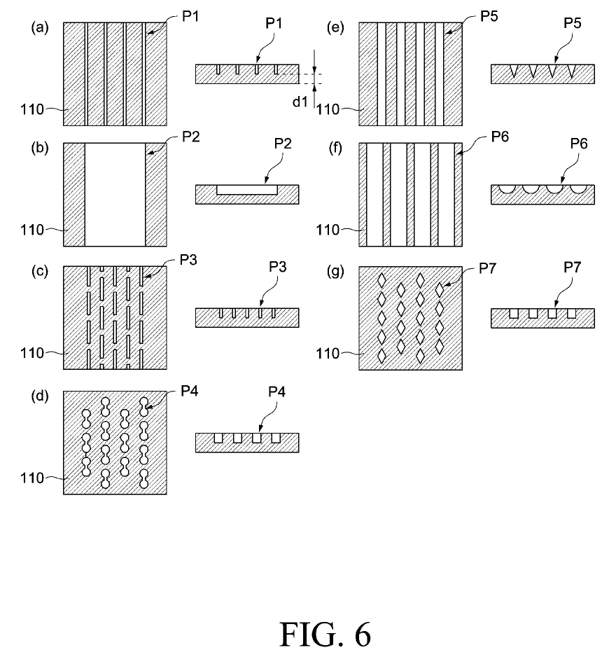

FIG. 6 is diagrams for explaining a concave pattern formed on a first substrate of a liquid crystal display device according to an example embodiment of the present disclosure.

First, referring to (a) of FIG. 6, the concave pattern P1 can have a rectangular shape in cross section. Further, the plurality of concave patterns P1 extends in a direction perpendicular to the folding direction of the first substrate 110 and is spaced apart in a direction parallel to the folding direction.

Meanwhile, the distance d1 between the lowermost end of the concave pattern P1 and the lower surface of the first substrate 110 is preferably 30 μm or more. When the distance d1 between the lowermost portion of the concave pattern P1 and the bottom surface of the first substrate 110 is less than 30 μm, cracks can occur in the concave pattern P1 or the first substrate 110 can be damaged when the first substrate 110 is bent.

Next, referring to (b) of FIG. 6, the concave pattern P2 can have a rectangular shape on one cross-section. Compared to (a) of FIG. 6, in (b) of FIG. 6, the concave pattern P2 can be a single pattern having a wide width and elongated in a direction perpendicular to the folding direction.

Referring to (c) of FIG. 6, the concave pattern P3 can have a rectangular shape in cross section. In this case, a plurality of concave patterns P3 can be formed to be spaced apart from each other in a direction perpendicular to the folding direction of the first substrate 110, and can be spaced apart from each other in a zigzag shape in the folding direction.

Referring to (d) of FIG. 6, the concave pattern P4 can have a shape in which two grooves having a circular shape in a plan view are connected to each other. For example, the concave pattern P4 can have a dumbbell shape on a plane, and can be formed in plural to be spaced apart in a direction perpendicular to the folding direction of the first substrate 110, and can be disposed to be spaced apart in a zigzag shape in the folding direction.

Referring to (e) of FIG. 6, the concave pattern P5 can have a triangular shape in cross section. In addition, the plurality of concave patterns P5 can be formed to be spaced apart from each other in a direction parallel to the folding direction with a shape elongated in a direction perpendicular to the folding direction of the first substrate 110.

Referring to (f) of FIG. 6, the concave pattern P6 can have a semicircular shape on a cross section. In addition, the plurality of concave patterns P6 can be formed to be spaced apart from each other in a direction parallel to the folding direction with a shape elongated in a direction perpendicular to the folding direction of the first substrate 110.

Referring to (g) of FIG. 6, the concave pattern P7 can have a rhombic shape on a plane. In addition, the plurality of concave patterns P7 can be formed to be spaced apart from each other in a direction parallel to the folding direction with a shape elongated in a direction perpendicular to the folding direction of the first substrate 110.

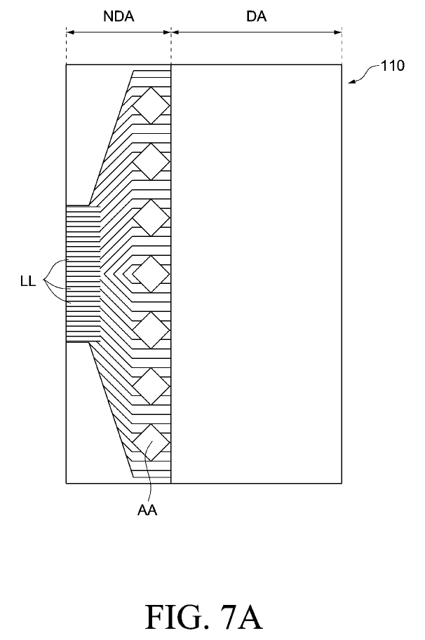

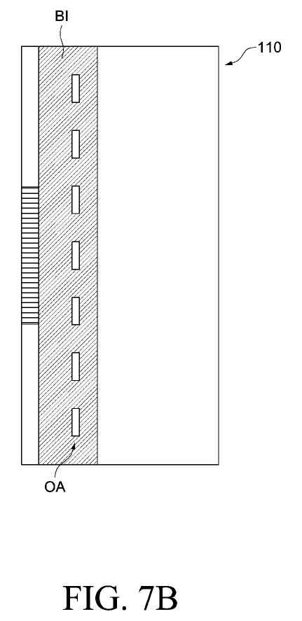

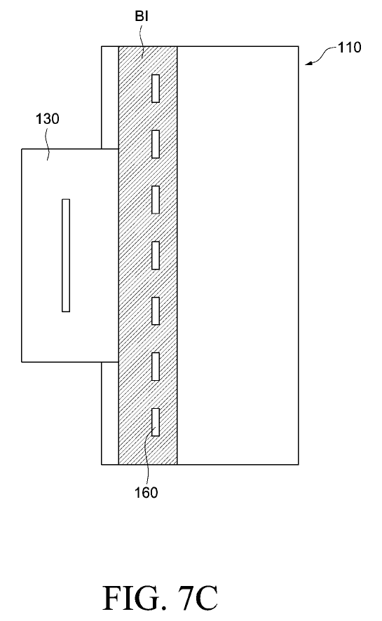

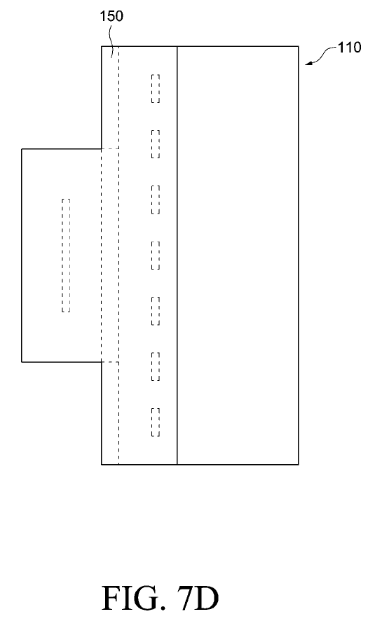

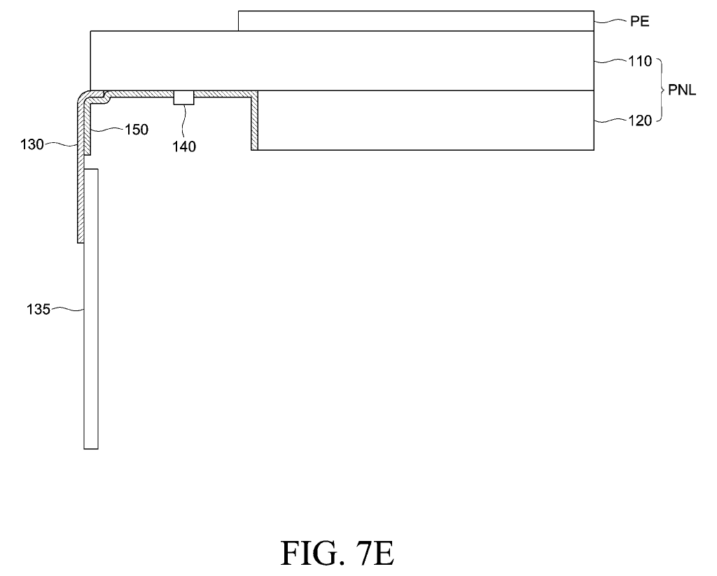

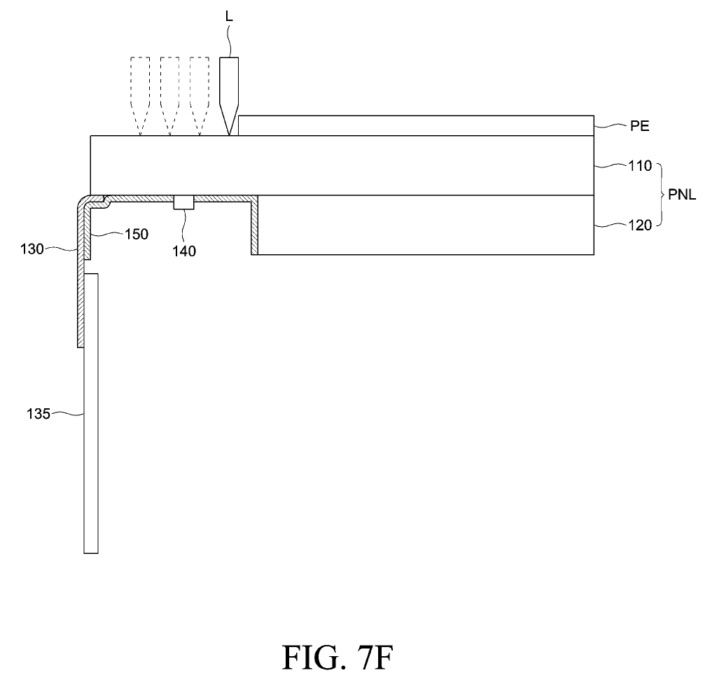

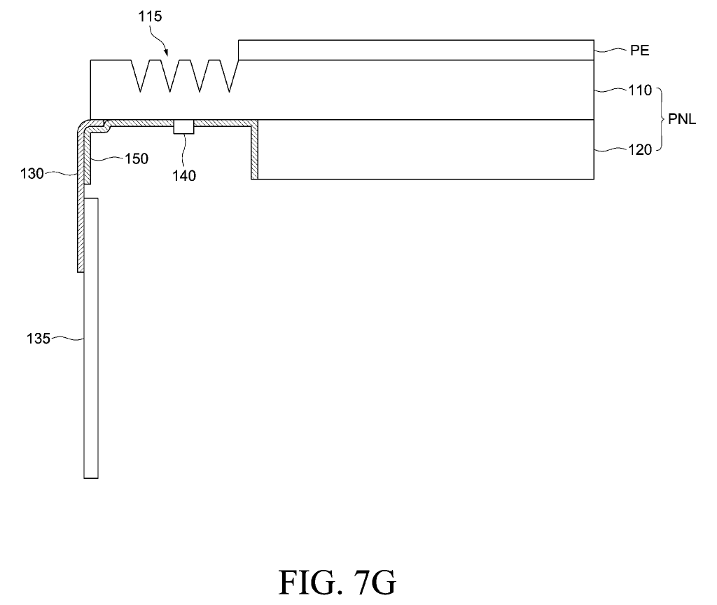

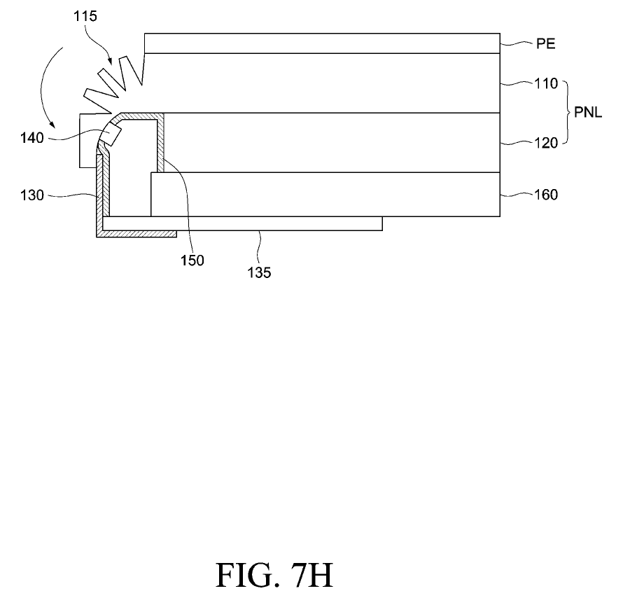

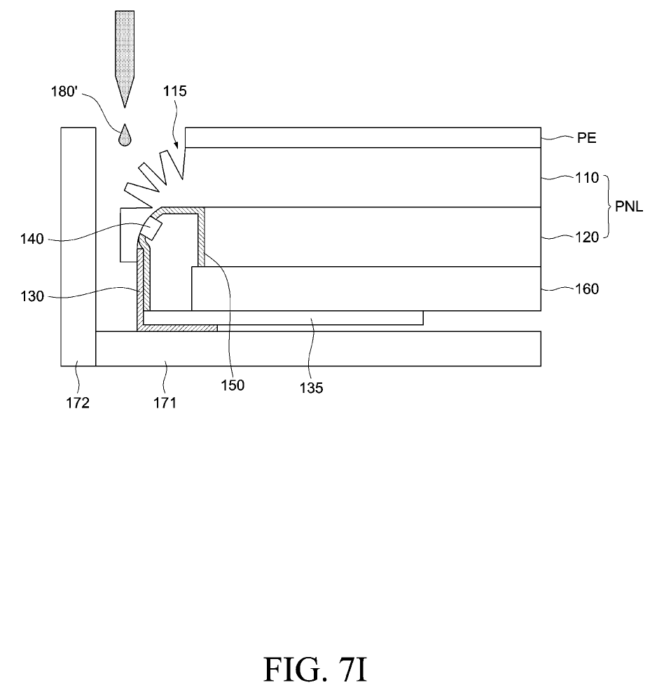

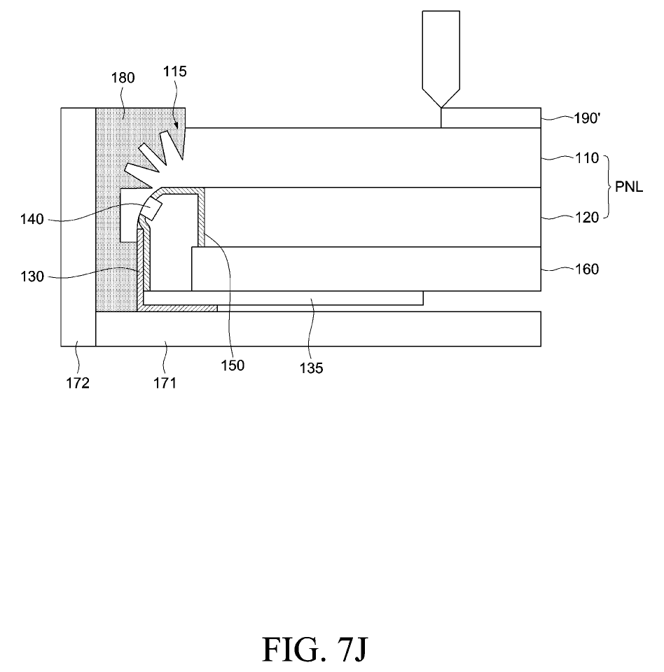

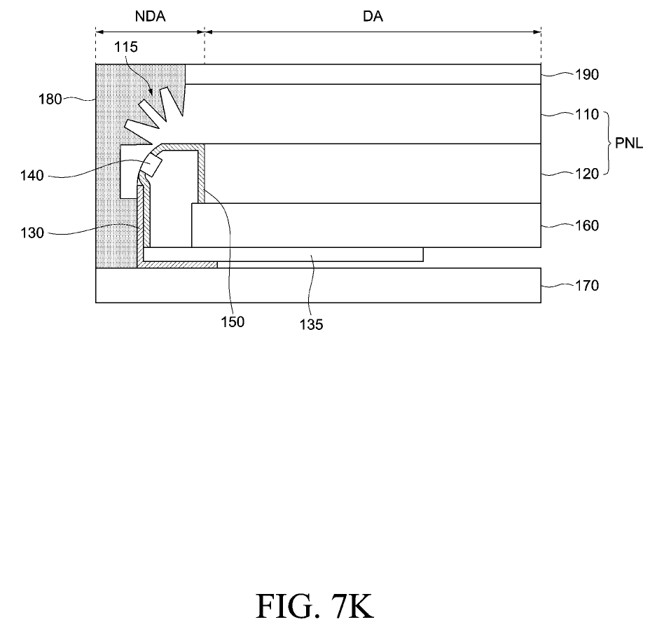

Hereinafter, a method of manufacturing a liquid crystal display device according to an example embodiment of the present disclosure will be described with reference to FIGS. 7A to 7K.

FIGS. 7A to 7K are schematic process diagrams for explaining a method of manufacturing a liquid crystal display device according to an example embodiment of the present disclosure. In this case, FIGS. 7A to 7D are schematic plan views for explaining a process of forming the flexible film 130, the light source 140, and the reflective layer 150 on the first substrate 110. FIGS. 7E to 7K are schematic plan views for explaining a process of forming the flexible film 130, the light source 140, and the reflective layer 150 on the first substrate 110, and are schematic cross-sectional views for explaining a bending process and a process of forming the black sealing material 180 and the protective coating layer 190.

Referring to FIG. 7A, a plurality of link lines LL is formed on the rear surface of the first substrate 110. In this case, in a subsequent process, only link lines LL connected to the light source 140 can be disposed in the area AA in which the light source 140 is disposed, and the link lines LL transmitting a driving signal, such as a data link line or gate link lines, can be disposed to avoid the area AA in which the light source 140 is disposed.

Referring to FIG. 7B, a black insulating layer BI is formed on the first substrate 110. The black insulating layer BI prevents contact between the wiring line and the reflective layer 150 and prevents light leakage from the light source 140. Therefore, the black insulating layer BI can be disposed on the bottom surface of the first substrate 110 corresponding to the non-display area NDA, except for an area AA in which the light source 140 is disposed and a pad area disposed at an end of the first substrate 110. In this case, the black insulating layer BI has a through hole OA formed so as to correspond to the area AA in which the light source 140 is disposed.

Referring to FIG. 7C, the flexible film 130 is attached to the end of the first substrate 110. The flexible film 130 is electrically connected to a plurality of link lines LL formed on the first substrate 110 through the pad area. Further, the light source 140 is mounted on the first substrate 110 so as to correspond to the through hole formed in the black insulating layer BI. In this case, the light source 140 can be connected to the link line LL of the light source 140 formed on the first substrate 110 using an anisotropic conductive film.

Referring to FIG. 7D, a reflective layer 150 is formed on a bottom surface of the first substrate 110 corresponding to the non-display area NDA. In order to prevent unintended light leakage when the light source 140 is disposed on the first substrate 110 positioned at the top toward the front surface, the reflective layer 150 can be disposed to cover the entire surface of the flexible film 130 as well as the first substrate 110 corresponding to the non-display area NDA. In this case, the reflective layer 150 can also be disposed on a side surface of the second substrate 120.

Next, referring to FIG. 7E, the printed circuit board 135 is connected to the other side of the flexible film 130. However, the printed circuit board 135 can be connected to the flexible film 130 in another step later. Further, a protective film PF can be disposed on the top surface of the first substrate 110 so as to correspond to the display area DA. The protective film PF protects the upper surface of the first substrate 110, which is the viewing surface, from risks occurring during the manufacturing process of the liquid crystal display device 100. However, the protective film PF can be attached to the upper surface of the first substrate 110 in another previous step.

Referring to FIGS. 7F and 7G, a concave pattern 115 is formed on the first substrate 110 so as to correspond to the non-display area NDA. The process of forming the concave pattern 115 on the first substrate 110, which is a glass substrate, is not limited, but a plurality of concave patterns 115 can be formed on the upper surface of the first substrate 110 by irradiating a laser and then performing an etching process. The laser irradiation process can be performed under different conditions depending on the size and shape of the plurality of concave patterns 115.

Referring to FIG. 7H, the first substrate 110 on which the concave pattern 115 is formed is bent downward. In this case, the flexible film 130 and the printed circuit board 135 connected to the first substrate 110 can be disposed on the rear surfaces of the display panel PNL and the light guide plate 160.

Referring to FIG. 7I, a bottom cover 170 for supporting and accommodating the liquid crystal display panel PNL and the light guide plate 160 is mounted thereon. The bottom cover 170 can include a horizontal portion 171 disposed to face a lower surface of the light guide plate 160 and a vertical portion 172 extending from the horizontal portion 171 and disposed to surround the liquid crystal display panel PNL and the side surface of the light guide plate 160. In this case, the vertical portion 172 is disposed adjacent to the first substrate 110 bent in the non-display area NDA. In order to implement a narrow bezel, the vertical portion 172 can be disposed to be in contact with the bent first substrate 110.

Referring to FIG. 7I, the black resin 180′ is filled in a space between the vertical portion 172 of the cover bottom 170 and the first substrate 110 to coat the upper portion of the first substrate 110 corresponding to the non-display area NDA. In this case, the vertical portion 172 of the bottom cover 170 provides a space for accommodating the black resin 180′. The black resin 180′ can be coated to derive a position higher than the top surface of the first substrate 110 in the display area. Thereafter, a black sealing material 180 is formed through a curing process.

Referring to FIG. 7J, the protective coating composition 190′ is coated on the top surface of the first substrate 110 so as to correspond to the display area DA. The protective coating layer 190 functions to planarize a portion of the black resin protruding more than the first substrate 110 in the process of forming the black sealing material 180.

Referring to FIG. 7K, the coating composition 190’ is cured to form the protective coating layer 190. The curing process can be selectively used depending on the coating composition 190’, but is not limited to a specific method.

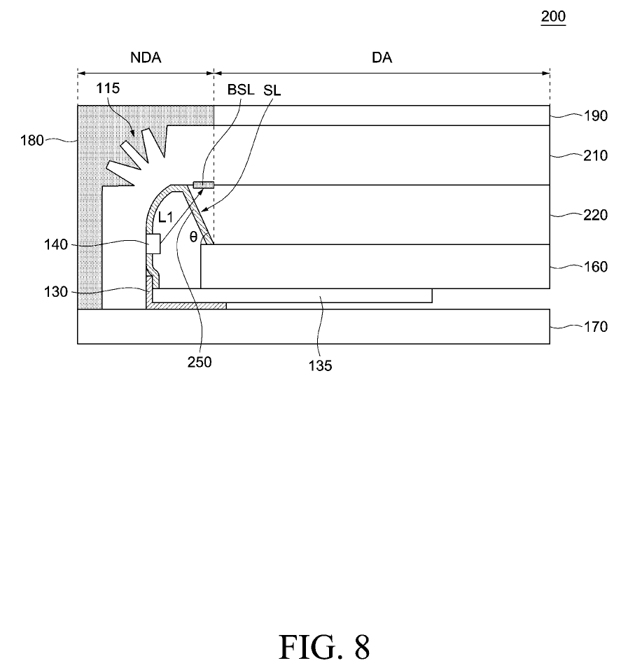

FIG. 8 is a schematic cross-sectional view of a liquid crystal display device according to another example embodiment of the present disclosure.

A liquid crystal display device 200 illustrated in FIG. 8 has the substantially same configurations as the liquid crystal display device 100 illustrated in FIG. 3 except that shapes of the first substrate 210 and the second substrate 220 in the non-display area NDA are different and a black light shielding layer BSL is further disposed, so that a redundant description will be omitted or may be briefly provided.

Referring to FIG. 8, a side portion of the first substrate 110 in the non-display area NDA extends to be in contact with the bottom cover 170. As compared with the display device illustrated in FIG. 3, the first substrate 110 has a structure further extending downward so that the position of the light source 140 can be changed so as to be adjacent to the light guide plate 160. The light source 140 is disposed adjacent to the side portion of the light guide plate 160 to improve the efficiency of light incident on the light guide plate 160.

In the non-display area NDA, the side portion of the second substrate 220 can have an inclined surface SL with an upper end positioned to be closer to the outside of the liquid crystal display device 100 and a lower end positioned to be adjacent to the display area DA. The inclined surface SL formed on the side portion of the second substrate 220 can easily reflect light emitted from the light source 140 in a downward direction by the reflective layer 150 disposed on the inclined surface SL.

Accordingly, it is possible to improve the efficiency of light incident on the light guide plate 160. In this case, the angle θ of the inclined surface SL can be 85° to 88°, but is not limited thereto. When the angle θ of the inclined surface SL satisfies the above range, it is easy to deposit the reflective layer 250 on the inclined surface SL of the second substrate 220.

Meanwhile, a black light shielding layer BSL is disposed between the first substrate 210 and the second substrate 220 in the non-display area NDA adjacent to the display area DA. The black light shielding layer BSL prevents a part of the light L1 emitted from the light source 140 from passing through the reflective layer 250 and being directed to the display area DA. Although the reflective layer 250 has a function of reflecting light, some light can pass or leak light depending on the constituent material or arrangement structure, and light directed to the display area DA causes a decrease in visibility of the user. Accordingly, the light leakage phenomenon can be suppressed through the black light shielding layer BSL.

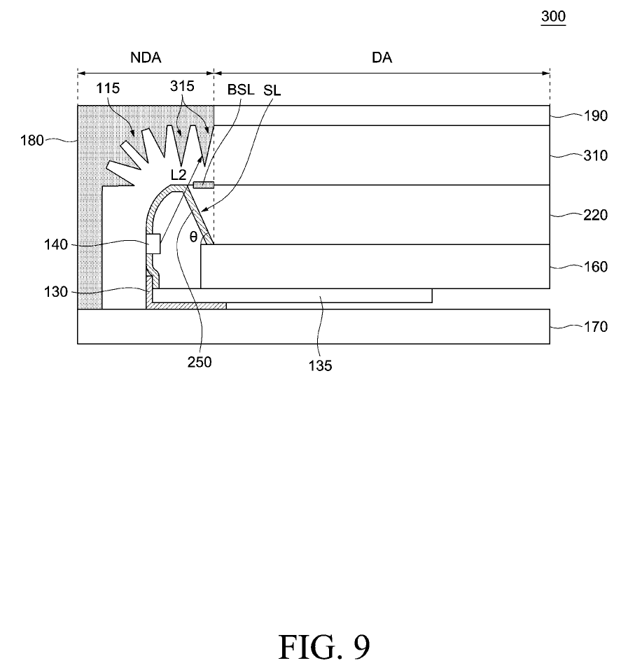

FIG. 9 is a schematic cross-sectional view of a liquid crystal display device according to still another example embodiment of the present disclosure.

A liquid crystal display device 300 illustrated in FIG. 9 has the substantially same configurations as the display device 200 illustrated in FIG. 8 except that an auxiliary concave pattern 315 formed on the first substrate 310 is further disposed, so that a redundant description will be omitted or may be briefly provided.

Referring to FIG. 9, a plurality of concave patterns is further included on a top surface of the first substrate 110 positioned in the non-display area NDA. Specifically, in addition to the concave pattern 115 formed to facilitate bending of the first substrate 110, an auxiliary concave pattern 315 disposed adjacent to the display area DA is further formed.

The auxiliary concave pattern 315 prevents a portion of the light L2 emitted from the light source 140 from being directed to the display area DA to avoid the black light shielding layer BSL. Even when the black light shielding layer BSL is disposed, light can leak out through the vicinity of the black light shielding layer BSL. Accordingly, when an additional auxiliary concave pattern 315 is formed in the non-display area NDA adjacent to the display area DA, the black sealing material 180 filled in the auxiliary concave pattern 315 can additionally perform a light blocking function. In this case, the auxiliary concave pattern 315 is disposed more adjacent to the display area DA than the concave pattern 115 formed for bending performance. In addition, the auxiliary concave pattern 315 can have a greater depth and width than the concave pattern 115 formed for bending performance.

The example embodiments of the present disclosure can also be described as follows:

According to an aspect of the present disclosure, there is provided a liquid crystal display device. The liquid crystal display device includes a first substrate including a display area and a non-display area and bent downward in the non-display area; a second substrate disposed below the first substrate; a light source disposed below the first substrate in the non-display area; a reflective layer disposed on a bottom surface of the first substrate and a side surface of the second substrate in the non-display area; a light guide plate disposed below the second substrate; a plurality of concave patterns formed on a top surface of the first substrate in the non-display area; and a black sealing material disposed outside the first substrate and the second substrate and filling the plurality of concave patterns.

The first substrate can include a plurality of thin film transistors, and the second substrate can include a black matrix and a color filter.

The plurality of concave patterns can have a shape in which a part of the first substrate is removed and recessed downward from the top surface.

Each of the plurality of concave patterns can extend long in a direction perpendicular to the bending direction and can be disposed to be spaced apart from each other in the bending direction.

The liquid crystal display device can further comprise an auxiliary concave pattern more adjacent to the display area than the plurality of concave patterns, and the auxiliary concave pattern can have a greater depth and width than the concave pattern.

The liquid crystal display device can further comprise a black light shielding layer disposed between the first substrate and the second substrate so as to be adjacent to the display area in the non-display area.

In the non-display area, a side portion of the second substrate has an inclined surface with an upper end positioned to be closer to the outside of the liquid crystal display device and a lower end positioned to be adjacent to the display area, and the reflective layer can cover the inclined surface.

The liquid crystal display device can further comprise a bottom cover disposed below the light guide plate. In the non-display area, a side portion of the first substrate can be in contact with the bottom cover, and the light source can be located on a side portion of the light guide plate.

The liquid crystal display device can further comprise a flexible film disposed on the first substrate in the non-display area; and a printed circuit board connected to the flexible film and disposed below the light guide plate, wherein the reflective layer can extend to the flexible film.

The liquid crystal display device can further comprise a data link line which is disposed on a bottom surface of the first substrate in the non-display area and transmits a data driving signal from the printed circuit board to the display area; a gate link line which is disposed on a bottom surface of the first substrate in the non-display area and transmits a gate driving signal from the printed circuit board to the display area; and a light source link line which is disposed on a bottom surface of the first substrate in the non-display area and transmits a light source driving signal from the printed circuit board to a light source, wherein the light source link line can be disposed between the first substrate and the light source.

The data link line and the gate link line do not overlap the light source.

The liquid crystal display device can further comprise a black insulating layer disposed between the gate link line and the reflective layer. The data link line and the gate link line can be disposed to overlap the reflective layer.

In the non-display area, a side portion of the second substrate has an inclined surface forming an angle of 85° to 88.°

A display device according to an example of the present disclosure can include a first substrate including a display area and a non-display area, the first substrate in the non-display area being bent downward in a bending direction; a second substrate disposed below the first substrate; a light source disposed below the first substrate in the non-display area; a reflective layer disposed on a bottom surface of the first substrate and a side surface of the second substrate in the non-display area; a flexible film disposed below and between the first substrate and the reflective layer in the non-display area; and a plurality of concave patterns disposed on a top surface of the first substrate in the non-display area.

The display device can further include a black sealing material disposed outside the first substrate and the second substrate, and filling the plurality of concave patterns.

Further, a portion of the reflective layer disposed on the side surface of the second substrate in the non-display area is disposed perpendicular to a portion of the reflective layer disposed on the bottom surface of the first substrate.

In another example, a portion of the reflective layer disposed on the side surface of the second substrate in the non-display area is slanted at an angle greater than 45°.Although the example embodiments of the present disclosure have been described in detail with reference to the accompanying drawings, the present disclosure is not limited thereto and can be embodied in various forms without departing from the technical concept of the present disclosure. Therefore, the example embodiments of the present disclosure are provided for illustrative purposes only but not intended to limit the technical concept of the present disclosure. The scope of the technical concept of the present disclosure is not limited thereto. Therefore, it should be understood that the above-described embodiments are illustrative in all aspects and do not limit the present invention. The protective scope of the present disclosure should be construed based on the following claims, and all the technical concepts in the equivalent scope thereof should be construed as falling within the scope of the present disclosure.

What is claimed is:

1. A liquid crystal display device, comprising:
a first substrate including a display area and a non-display area, the first substrate being bent downward in a bending direction in the non-display area;
a second substrate disposed below the first substrate;
a light source disposed below the first substrate in the non-display area;
a reflective layer disposed on a bottom surface of the first substrate and a side surface of the second substrate in the non-display area;
a light guide plate disposed below the second substrate;
a plurality of concave patterns disposed on a top surface of the first substrate in the non-display area; and
a black sealing material disposed outside the first substrate and the second substrate, and filling the plurality of concave patterns.

2. The liquid crystal display device according to claim 1, wherein the first substrate includes a plurality of thin film transistors, and
the second substrate includes a black matrix and a color filter.

3. The liquid crystal display device according to claim 1, wherein the plurality of concave patterns has a shape in which a part of the first substrate is removed and recessed downward from the top surface thereof.

4. The liquid crystal display device according to claim 3, wherein each of the plurality of concave patterns extends in a direction perpendicular to the bending direction and is spaced apart from each other in the bending direction.

5. The liquid crystal display device according to claim 3, further comprising:
an auxiliary concave pattern more adjacent to the display area than the plurality of concave patterns.

6. The liquid crystal display device according to claim 5, wherein the auxiliary concave pattern has a greater depth and width than at least one of the plurality of concave patterns.

7. The liquid crystal display device according to claim 1, further comprising:
a black light shielding layer disposed between the first substrate and the second substrate so as to be adjacent to the display area in the non-display area.

8. The liquid crystal display device according to claim 1, wherein in the non-display area, a side portion of the second substrate has an inclined surface with an upper end positioned to be closer to an outside of the liquid crystal display device and a lower end positioned to be adjacent to the display area, and the reflective layer covers the inclined surface of the second substrate.

9. The liquid crystal display device according to claim 1, further comprising:
a bottom cover disposed below the light guide plate,
wherein in the non-display area, a side portion of the first substrate is in contact with the bottom cover, and
the light source is located on a side portion of the light guide plate.

10. The liquid crystal display device of claim 1, further comprising:
a flexible film disposed on the first substrate in the non-display area; and
a printed circuit board connected to the flexible film and disposed below the light guide plate,
wherein the reflective layer extends to the flexible film.

11. The liquid crystal display device according to claim 10, further comprising:
a data link line disposed on a bottom surface of the first substrate in the non-display area, and configured to transmit a data driving signal from the printed circuit board to the display area; and
a gate link line disposed on a bottom surface of the first substrate in the non-display area, and configured to transmit a gate driving signal from the printed circuit board to the display area.

12. The liquid crystal display device of claim 11, further comprising:
a light source link line disposed on a bottom surface of the first substrate in the non-display area, and configured to transmit a light source driving signal from the printed circuit board to the light source,
wherein the light source link line is disposed between the first substrate and the light source.

13. The liquid crystal display device of claim 11, wherein the data link line and the gate link line does not overlap the light source.

14. The liquid crystal display device of claim 11, further comprising:
a black insulating layer disposed between the data link line and the gate link line and the reflective layer,
wherein the data link line and the gate link line are disposed so as to overlap the reflective layer.

15. The liquid crystal display device of claim 3, wherein a distance between a lowermost end of the plurality of concave patterns and a lower surface of the first substrate is 30 μm or more.

16. The liquid crystal display device of claim 1, wherein in the non-display area, a side portion of the second substrate has an inclined surface forming an angle of 85° to 88.°

17. A display device, comprising:
a first substrate including a display area and a non-display area, the first substrate in the non-display area being bent downward in a bending direction;
a second substrate disposed below the first substrate;
a light source disposed below the first substrate in the non-display area;
a reflective layer disposed on a bottom surface of the first substrate and a side surface of the second substrate in the non-display area;
a flexible film disposed below and between the first substrate and the reflective layer in the non-display area; and
a plurality of concave patterns disposed on a top surface of the first substrate in the non-display area.

18. The display device of claim 17, further comprising:
a black sealing material disposed outside the first substrate and the second substrate, and filling the plurality of concave patterns.

19. The display device of claim 17, wherein a portion of the reflective layer disposed on the side surface of the second substrate in the non-display area is disposed perpendicular to a portion of the reflective layer disposed on the bottom surface of the first substrate.

20. The display device of claim 17, wherein a portion of the reflective layer disposed on the side surface of the second substrate in the non-display area is slanted at an angle greater than 45°.
